(19) United States
(12) Patent Application Publication
(10) Pub. No.: US 2007/0091984 A1
(43) Pub. Date: Apr. 26, 2007

(54) Dual-Carrier Modulation Decoder

(75) Inventors: Anuj Batra, Dallas, TX (US); Srinivas Lingam, Dallas, TX (US); Jaiganesh Balakrishnan, Bangalore (IN)

Correspondence Address: TEXAS INSTRUMENTS INCORPORATED, P O BOX 655474, M/S 3999, DALLAS, TX, 75265, US

(73) Assignee: Texas Instruments Incorporated, Dallas, TX (US)

(21) Appl. No.: 11/551,980

(22) Filed: Oct. 23, 2006

Related U.S. Application Data
(60) Provisional application No. 60/729,521, filed on Oct. 24, 2005.

(51) Int. Cl. H04B 1/00

(52) U.S. Cl. 375/130

(57) ABSTRACT

Communications systems are disclosed which comprise system and methods which, in some embodiments, include a data input; a decoding function, which is adapted to receive a first data element and a second data element from the data input and decode the first data element and second data element, and a mapping element, which is adapted to map the first data element and second data element onto two constellations.

### CROSS-REFERENCE TO RELATED APPLICATIONS

This application claims priority under 35 U.S.C. §119(e) to U.S. patent application Ser. No. 60/729,521 entitled “Dual-Carrier Modulation (DCM) Decoder”, filed on Oct. 24, 2005, which is incorporated herein by reference for all purposes.

### STATEMENT REGARDING FEDERALLY SPONSORED RESEARCH OR DEVELOPMENT

Not applicable.

### REFERENCE TO A MICROFICHE APPENDIX

Not applicable.

### BACKGROUND

Next generation networks, such as WiMedia, increase the range, speed, and reliability of wireless data networks. One implementation of next generation networks utilizes ultra wideband (UWB) wireless technology. UWB wireless technology offers fantastic potential for bandwidth intensive multimedia applications. MultiBand OFDM physical layer (PHY) radio uses a sophisticated medium access control (MAC) layer that can deliver throughput up to 480 megabits per second (Mbps). This technology can be optimized for long range mobile multimedia applications. Additionally, the networks provide for fast device discovery and association so that devices can quickly and easily join and leave an ad-hoc network.

WiMedia refers to the UWB common radio platform that enables high-speed (480 Mbps and beyond), low power consumption data transfers in a wireless personal area network (WPAN). The WiMedia UWB common radio platform incorporates MAC layer and PHY layer specifications based on MultiBand orthogonal frequency-division multiplexing (MB-OFDM). WiMedia UWB is optimized for the personal computer (PC), consumer electronics (CE), mobile device and automotive market segments. ECMA-368 and ECMA-369 are international ISO-based specifications for the WiMedia UWB common radio platform. Additional information may be found in U.S. Patent Application No. 2005/0232137, entitled “Versatile System for Dual Carrier Transformation in Orthogonal Frequency Division Multiplexing”, by Hosur, Balakrishnan, and Batra filed on Oct. 20, 2005, which is incorporated herein by reference for all purposes.

### SUMMARY

In one disclosed embodiment, an ultra-wideband wireless communications system is disclosed which comprises a data input, a decoding function, adapted to receive a first data element and a second data element from the data input and decode the first data element and second data element, and a mapping element, adapted to map the first data element and second data element onto a first constellation and a second first constellation.

In another disclosed embodiment, a method of network communications is disclosed which comprises receiving a signal containing a tone pair, reordering the signal to account for any intermediate tones transmitted in between the tone pair, and decoding the signal.

In yet another disclosed embodiment, a method for network communications is disclosed which comprises receiving data, creating two constellations using the data, separating the data into at least two separate pairs, and introducing a delay between the transmission of the first pair and the second pair. This method also comprises detecting an error in the first pair, and recovering first pair data using the second pair.

These and other features and advantages will be more clearly understood from the following detailed description taken in conjunction with the accompanying drawings and claims.

### BRIEF DESCRIPTION OF THE DRAWINGS

For a more complete understanding of the present disclosure and the advantages thereof, reference is now made to the following brief description, taken in connection with the accompanying drawings and detailed description, wherein like reference numerals represent like parts.

FIG. 1 is a block diagram of a DCM system.

FIG. 2 is an illustration of a sixteen point constellation.

FIG. 3 is a method of joint decoding.

FIG. 4 is a method of joint decoding using approximation.

FIG. 5 illustrates an exemplary general-purpose computer system suitable for implementing the several embodiments of the disclosure.

FIG. 6 illustrates an exemplary MAC, PHY, and MAC-PHY interface suitable for implementing the several embodiments of the disclosure.

### DETAILED DESCRIPTION

It should be understood at the outset that although an exemplary implementation of one embodiment of the present disclosure is illustrated below, the present system may be implemented using any number of techniques, whether currently known or in existence. The present disclosure should in no way be limited to the exemplary implementations, drawings, and techniques illustrated below, including the exemplary design and implementation illustrated and described herein, but may be modified within the scope of the appended claims along with their full scope of equivalents.

The present disclosure, in some embodiments, provides systems and methods for implementing a dual carrier modulation (DCM) decoder with joint decoding. Joint decoding accepts a stream of data which has been broken up into a first tone and a second tone. The first tone and second tone may be referred to collectively as a single tone pair. In one embodiment, the DCM encoder maps a predetermined number of symbols from the tone pair onto a first constellation and a second constellation, and then maps these symbols onto two separate tones. The first tone and second tone are then transmitted with a predetermined number of tones being inserted in between the transmission of the first tone and the second tone. The DCM decoder accepts this data, reorders the data and, in some embodiments, recreates the constellations. The phrase joint decoder is intended to refer to the process by which the DCM decoder uses two separate tones concurrently to decode the tone pair. If one of the bits within one of the tones is lost or degraded, it can be identified or recovered by the DCM decoder, using mathematical techniques as discussed below.

Some of the present embodiments are hereafter illustratively described in conjunction with the design and operation of an ultra-wideband (UWB) communications system utilizing an Orthogonal Frequency Division Multiplexing (OFDM) scheme. Certain aspects of the present disclosure are further detailed in relation to design and operation of a Multi-band OFDM (MBOFDM) UWB communications system. Although described in relation to such constructs and operations, the teachings and embodiments disclosed herein may be beneficially implemented with any data transmission or communication systems or protocols (e.g., IEEE 802.11(a)), depending upon the specific needs or requirements of such systems. Ecma International has published WiMedia standard ECMA-368 entitled, “High Rate Ultra Wideband PHY and MAC Standard”, and ECMA-369 entitled, “MAC-PHY Interface for ECMA-368”, which are hereby incorporated herein by reference as if reproduced in full, and can be utilized in conjunction with the present embodiments.

OFDM-based wireless communication systems commonly utilize a pre-transmission conversion function to convert a data signal from the frequency domain into the time domain for OTA transmission over a wireless channel. During transmission over the wireless channel, some degree of signal noise (e.g., interference) is added to the time domain data signal. As the time domain signal is received, a post-transmission conversion function is utilized to convert the signal back into the frequency domain, for subsequent signal processing or communication. Often, such pre-transmission and post-transmission conversion functions take the form of Inverse Fast Fourier Transforms (IFFTs) and Fast Fourier Transforms (FFTs), respectively.

Within the context of an OFDM-based UWB system, a pre-transmission IFFT commonly has 128 points (or tones). Depending upon the type of communications system, or specific design or performance requirements, however, an IFFT may have any desired or required number of tones. In some embodiments, one hundred of those tones are used as data carriers, twelve are pilot carriers (i.e., carry data known to receiver that it uses to ensure coherent detection), ten are guard carriers, and six are null tones. The ten guard carriers may be configured to serve a number of concurrent or independent functions. For example, some portion of the guard tones may be configured to improve signal-to-noise ratios (SNRs), by loading those guard carriers with critical data (e.g., unreliable data) for redundant transmission. Some portion of the guard tones may be configured (e.g., left unutilized) as frequency guard bands, to prevent interference to or from adjacent frequency bands. Of the six null tones, one typically occupies the middle of the available signal spectrum, and the others may be selectively configured or designated to conform to a desired spectral mask (e.g., UWB, 802.11, 802.16).

Within a MBOFDM system, data tones across different bands are typically loaded with quadrature phase-shift key (QPSK) data. For a high-throughput MBOFDM system, there are a number of techniques that may be used to manipulate or tailor system data rates. Typically, such systems employ some sort of convolutional code for error detection/correction purposes. For example, in a UWB MBOFDM system, an [R=⅓, k=7] convolutional code may be provided as a forward error correction (FEC) code. Such codes can be manipulated by various puncturing schemes to achieve a desired data rate (e.g., [R=¾, k=7] for 480 Mbps). In addition to code puncturing, techniques such as frequency domain spreading and time domain spreading may be employed to divide down to a desired data rate.

Frequency spreading and time spreading are two techniques which introduce redundancy into the transmission of data. However, with emerging wireless technology, such as Wimedia, frequency spreading and time spreading are not available. This problem is addressed by the present disclosure since the breaking up of data by the DCM enables the creation of two constellations which allows for data recover without frequency spreading and time spreading techniques. Therefore, one of the innovative features of the present disclosure is the ability to compensate for the lack of frequency spreading or time spreading by joint decoding tones in pairs which are separated by a known delay.

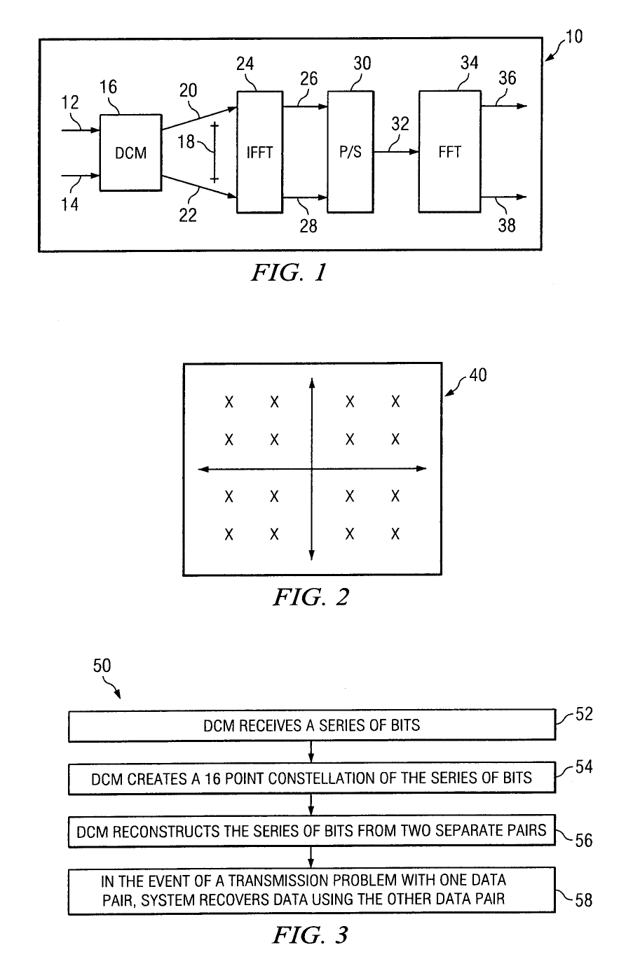

FIG. 1 is a block diagram 10 of a system using DCM 16. The input to the system is a first QPSK 12 and a second QPSK 14. DCM 16 maps first QPSK 12 and second QPSK 14 onto a first tone 20 and a second tone 22. Each QPSK contains, in some embodiments, two data elements. A data element may include, but is not limited to, a single bit of data. It is contemplated that a delay 18 may, in some embodiments, be present between the transmission of the first tone 20 and second tone 22. In some embodiments, this delay may be maximized in order to allow for enhanced error recovery. The following examples use a fifty tone delay, however, it is expressly understood that any number of tone delays could be used, and that more or less than a fifty tone delay could be used consistent with this disclosure. First tone 20 and second tone 22 are transmitted into IFFT 24. IFFT 24 performs an IFFT on first tone 20 creating first sample 26 and performs an IFFT on second tone 22 creating second sample 28. First sample 26 and second sample 28 are transmitted into phase shifter (P/S) 30 which transmits a signal 32 into FFT 34. FFT 34 is then capable of recovering third tone 36 which is substantially similar to first tone 20 and recovering fourth tone 38 which is substantially similar to the second tone 22.

One of the innovative approaches of the present disclosure is the approach by which the recovery of third tone 36 and fourth tone 38 is made. According to one embodiment of the present disclosure two sixteen point constellations are created by DCM 16, one of which is illustrated by constellation 40 shown in FIG. 2. DCM 16 is capable, in some embodiments, of mapping the same group of symbols to a first 16-point constellation and a second 16-point constellation, thus creating the two tone pairs. In should be understood that the mapping used by DCM 16 to create the first 16-point constellation and the second 16-point constellation may, in some embodiments, be dissimilar. This dissimilar arrangement is intended to refer to the placement of a symbol to a first location within a first 16-point constellation and the placement of the same symbol to a second location within a second 16-point constellation.

One of the innovative features of the constellation pair is the ability to maximize available information through the combination of the first constellation and the second constellation. In some situations, if a tone is lost or faded, then the tone may be recovered by using either the first 16-point constellation or the second 16-point constellation. As is shown in constellation 40, there is a predetermined pattern of points which makes up constellation 40 from which individual points may be extrapolated. This is well known to one skilled in the art. Constellation 40 is made possible through the joint decoding of two separate tones. By spreading the data over a longer duration separated by delay 18, the probability that all elements of the tone pair will be degraded is greatly reduced. While the embodiment discussed uses a 16 point constellation, it is expressly understood that any number of points could be used to create a constellation. It is further expressly understood that while the same number of points are used in the previous examples, constellations containing a dissimilar number of points may be used consistent with the disclosed embodiments.

Dual-carrier modulation was added to the WiMedia 1.0 PHY specification in order to exploit channel diversity at the higher data rates, where no additional forms of spreading are available. The mapping between the QPSK symbol on the kth tone, sₖ, and the DCM symbol on the kth tone, dₖ, is illustrated as equation (1) where Dₖ=[dₖdₖ₊₅₀]^{T}, Sₖ=[sₖ sₖ₊₅₀]^{T}.
Dₖ=TSₖ (1)

The mixing matrix from equation (1) is illustrated as equation (2).

$$T = \frac{1}{\sqrt{5}} [ \begin{matrix}2 & 1 \\ 1 & - 2\end{matrix} ] \qquad ( 2 )$$

In one embodiment, the resulting DCM symbol will be a point selected from a first and second 16-point constellation where T=T^{T}.

In one embodiment of the present disclosure, the maximum likelihood DCM decoder approach is used. In this embodiment, after FFT 34, the received signal 32 rₖ for the kth tone can be written as equation (3) where hₖ is the channel coefficient for the kth tone and nₖ is a white Gaussian random variable with variance σ2.
rₖ=hₖdₖ+nₖ (3)

The received vector Rₖ=[rₖrₖ₊₅₀]^{T}, which represents the received signal 32, in this embodiment, for the kth and (k+50)th tones, can be written in matrix notation as shown by equation (4). The “50” term in the (k+50) is the delay 18 value introduced by DCM 16. It is expressly contemplated that any delay may be used as delay 18. The number “50” is used because it is the value that gives the maximum separation between tones in one preferred embodiment. Since transmission errors may affect more than one bit in sequence, by using the maximum delay between bits within the constellation allows for minimizing the probability that unrecoverable errors due to consecutive errors will occur.
Rₖ=HₖDₖ+Nₖ (4)

In some embodiments, Nₖ=[nₖ nₖ₊₅₀]^{T}. One example of a representation for Hₖ is shown in equation (5).

$${H}_{k} = [ \begin{matrix}{h}_{k} & 0 \\ 0 & {h}_{k + 50}\end{matrix} ] \qquad ( 5 )$$

The output used in this embodiment from the frequency-domain equalizer (FEQ), Yₖ, can be written as equation (6).
Yₖ=Hₖ*Rₖ=|Hₖ|²Dₖ+Hₖ*Nₖ=|Hₖ|²TSₖ+Hₖ*Nₖ (6)

One example of a representation for |Hₖ|² is shown in equation (7).

$${\vert {H}_{k} \vert}^{2} = [ \begin{matrix}{\vert {h}_{k} \vert}^{2 } & 0 \\ 0 & {\vert {h}_{k + 50} \vert}^{2 }\end{matrix} ] \qquad ( 7 )$$

In this embodiment, the interleaved and coded bits [b₂ₖ b₂ₖ₊₁] are mapped to the QPSK symbols (sₖ) as illustrated by equation (8). It should be noted that the QPSK includes both real and imaginary values.
sₖ=(2b₂ₖ−1)+j(2b₂ₖ₊₁−1) (8)

The QPSK symbols of equation (8) can be written as shown by equation (9) in vector notation where B₂ₖ=[b₂ₖ b₂ₖ+100]^{T} and 1₂=[1 1]^{T}.
Sₖ=(2B₂ₖ−1₂)+j(2B₂ₖ₊₁−1₂) (9)

It is understood that the output, Re(Yₖ), is only a function of B₂ₖ as shown by equation (10).
Re(Yₖ)=2|Hₖ|²TB₂ₖ−|Hₖ|²T1₂+Re(Hₖ*Nₖ) (10)

Given the previous equations, the log-likelihood ratio (LLR) for b₂ₖ, b₂ₖ₊₁₀₀, b₂ₖ₊₁, and b₂ₖ₊₁₀₁ can be determined. A likelihood-ratio test is a statistical test in which the ratio is computed between the maximum of the likelihood (ML) function under the null hypothesis and the maximum with that constraint relaxed. In one embodiment, the LLR may be used to determine the probability that a single discrete point, bit, or tone is accurately received.

The LLR for b₂ₖ is given by: equation (11) where α k=[Re(yₖ)Re(yₖ+50)]^{T}.

$$\begin{matrix}LLR ( {b}_{2 k} ) = log [ \frac{{\sum }_{{b}_{2 k + 100}} Pr ( {Y}_{k} \vert {b}_{2 k} = 1 , {b}_{2 k + 100} )}{{\sum }_{{b}_{2 k + 100}} Pr ( {Y}_{k} \vert {b}_{2 k} = 0 , {b}_{2 k + 100} )} ] \\ = log \{ \frac{\begin{matrix}[ {\sum }_{{b}_{2 k + 100}} exp [ - {( {α}_{k} - 2 {\vert {H}_{k} \vert}^{2} {TB}_{2 k} + {\vert {H}_{k} \vert}^{2} T {1}_{2} )}^{T} \\ \frac{1}{{σ}^{2}} {\vert {H}_{k} \vert}^{- 2} ( {α}_{k} - 2 {\vert {H}_{k} \vert}^{2} {TB}_{2 k} + {\vert {H}_{k} \vert}^{2} T {1}_{2} ) ] \vert {b}_{2 k} = 1 ]\end{matrix}}{\begin{matrix}[ {\sum }_{{b}_{2 k + 100}} exp [ - {( {α}_{k} - 2 {\vert {H}_{k} \vert}^{2} {TB}_{2 k} + {\vert {H}_{k} \vert}^{2} T {1}_{2} )}^{T} \\ \frac{1}{{σ}^{2}} {\vert {H}_{k} \vert}^{- 2} ( {α}_{k} - 2 {\vert {H}_{k} \vert}^{2} {TB}_{2 k} + {\vert {H}_{k} \vert}^{2} T {1}_{2} ) ] \vert {b}_{2 k} = 0 ]\end{matrix}} \}\end{matrix} \qquad ( 11 )$$

By expanding (11) and eliminating the terms that do not depend on B₂ₖ, the previous equation can be re-written as equation (12)

$$LLR ( {b}_{2 k} ) = log \{ \frac{[ {\sum }_{{b}_{2 k + 100}} exp [ \frac{- 4}{{σ}^{2}} {B}_{2 k}^{T} T \{ {\vert {H}_{k} \vert}^{2} T ( {B}_{2 k} - {1}_{2} ) - {α}_{k} \} ] \vert {b}_{2 k} = 1 ]}{[ {\sum }_{{b}_{2 k + 100}} exp [ \frac{- 4}{{σ}^{2}} {B}_{2 k}^{T} T \{ {\vert {H}_{k} \vert}^{2} T ( {B}_{2 k} - {1}_{2} ) - {α}_{k} \} ] \vert {b}_{2 k} = 0 ]} \} \qquad ( 12 )$$

Similarly, the LLR equations for b₂ₖ₊₁₀₀ (13), b₂ₖ₊₁ (14), and b₂ₖ₊₁₀₁ (15) can be written where βₖ=[Im(yₖ)Im(yₖ₊₅₀)]^{T}.

$$\begin{matrix}LLR ( {b}_{2 k + 100} ) = log \{ \frac{[ {\sum }_{{b}_{2 k}} exp [ \frac{- 4}{{σ}^{2}} {B}_{2 k}^{T} T \{ {\vert {H}_{k} \vert}^{2} T ( {B}_{2 k} - {1}_{2} ) - {α}_{k} \} ] \vert {b}_{2 k + 100} = 1 ]}{[ {\sum }_{{b}_{2 k}} exp [ \frac{- 4}{{σ}^{2}} {B}_{2 k}^{T} T \{ {\vert {H}_{k} \vert}^{2} T ( {B}_{2 k} - {1}_{2} ) - {α}_{k} \} ] \vert {b}_{2 k + 100} = 0 ]} \} & ( 13 ) \\ LLR ( {b}_{2 k + 1} ) = log \{ \frac{[ {\sum }_{{b}_{2 k + 1}} exp [ \frac{- 4}{{σ}^{2}} {B}_{2 k + 1}^{T} T \{ {\vert {H}_{k} \vert}^{2} T ( {B}_{2 k + 1} - {1}_{2} ) - {β}_{k} \} ] \vert {b}_{2 k + 1} = 1 ]}{[ {\sum }_{{b}_{2 k + 1}} exp [ \frac{- 4}{{σ}^{2}} {B}_{2 k + 1}^{T} T \{ {\vert {H}_{k} \vert}^{2} T ( {B}_{ 2 k + 1} - {1}_{ 2} ) - {β}_{ k} \} ] \vert {b}_{ 2 k + 1} = 0 ]} \} & ( 14 ) \\ LLR ( {b}_{2 k + 101} ) = log \{ \frac{[ {\sum }_{{b}_{2 k + 100}} exp [ \frac{- 4}{{σ}^{2}} {B}_{2 k + 1}^{T} T \{ {\vert {H}_{k} \vert}^{2} T ( {B}_{2 k + 1} - {1}_{2} ) - {β}_{k} \} ] \vert {b}_{2 k + 101} = 1 ]}{[ {\sum }_{{b}_{2 k + 100}} exp [ \frac{- 4}{{σ}^{2}} {B}_{2 k + 1}^{T} T \{ {\vert {H}_{k} \vert}^{2} T ( {B}_{2 k + 1} - {1}_{2} ) - {β}_{k} \} ] \vert {b}_{2 k + 101} = 0 ]} \} & ( 15 )\end{matrix}$$

It is expressly understood that it is possible to simplify the equations further by multiplying the matrices by the vectors. It is understood that this is an exact approach to the calculation of the LLR. However, approximations may be used in order to reduce the complexity, such as the number of electronic gates, required to implement the exact approach. Using the LLR approach, a constellation may be created from tones which have a high probability of being accurately received.

One example of an approximation that may be used to reduce the complexity of the LLR equations is through the max-log approximation. It should be understood that any method of calculating the LLR in conjunction with a delay introduced into the transmission of tones is contemplated by the present disclosure. The following expression can be used to express the generic format of equations (12), (13), (14), and (15):
LLR=log(exp(A)+exp(B))−log(exp(X)+exp(Y)). (16)

The first term in (16) can be written as shown in equation (17)

$$log ( exp ( A ) + exp ( B ) ) = log [ max \{ exp ( A ) , exp ( B ) \} ] + log [ 1 + \frac{min \{ exp ( A ) , exp ( B ) \}}{max \{ exp ( A ) , exp ( B ) \}} ] \qquad ( 17 )$$

In the high SNR case, the last term in (17) can be ignored and therefore, the following approximation can be used to simplify the LLR equations:
log(exp(A)+exp(B))≈log[max{exp(A), exp(B)}] (18)

In one embodiment, by using equation (18) the log & max operations may be interchanged to result in max{A,B}. An example of this is shown in equation (19).
log(exp(A)+exp(B))≈max{A,B} (19)

Using equation (18), expanding the matrices within (12), (13), (14), and (15), and substituting for T, the reduced complexity LLR equations can be expressed as equations (20), (21), (22) and (23):

$$\begin{matrix}LLR ( {b}_{2 k} ) = max \{ [ 3 Re ( {y}_{k} ) - Re ( {y}_{k + 50} ) ] , [ 2 Re ( {y}_{k} ) + Re ( {y}_{k + 50} ) + 2 / \sqrt{5} ( {\vert {h}_{k} \vert}^{2} - {\vert {h}_{k + 50} \vert}^{2} ) ] \} - max \{ [ Re ( {y}_{k} ) + 2 Re ( {y}_{k + 50} ) + 2 / \sqrt{5} ( {\vert {h}_{k} \vert}^{2} - {\vert {h}_{k + 50} \vert}^{2} ) ] , 0 \} . & ( 20 ) \\ LLR ( {b}_{2 k + 100} ) = max \{ [ 3 Re ( {y}_{k} ) - Re ( {y}_{k + 50} ) ] , [ Re ( {y}_{k} ) + 2 Re ( {y}_{k + 50} ) + 2 / \sqrt{5} ( {\vert {h}_{k} \vert}^{2} - {\vert {h}_{k + 50} \vert}^{2} ) ] \} - max \{ [ 2 Re ( {y}_{k} ) + Re ( {y}_{k + 50} ) + 2 / \sqrt{5} ( {\vert {h}_{k} \vert}^{2} - {\vert {h}_{k + 50} \vert}^{2} ) ] , 0 \} . & ( 21 ) \\ LLR ( {b}_{2 k + 1} ) = max \{ [ 3 Im ( {y}_{k} ) - Im ( {y}_{k + 50} ) ] , [ 2 Im ( {y}_{k} ) + Im ( {y}_{k + 50} ) + 2 / \sqrt{5} ( {\vert {h}_{k} \vert}^{2} - {\vert {h}_{k + 50} \vert}^{2} ) ] \} - max \{ [ Im ( {y}_{k} ) + 2 Im ( {y}_{k + 50} ) + 2 / \sqrt{5} ( {\vert {h}_{k} \vert}^{2} - {\vert {h}_{k + 50} \vert}^{2} ) ] , 0 \} . & ( 22 ) \\ LLR ( {b}_{2 k + 101} ) = max \{ [ 3 Im ( {y}_{k} ) - Im ( {y}_{k + 50} ) ] , [ Im ( {y}_{k} ) + 2 Im ( {y}_{k + 50} ) + 2 / \sqrt{5} ( {\vert {h}_{k} \vert}^{2} - {\vert {h}_{k + 50} \vert}^{2} ) ] \} - max \{ [ 2 Im ( {y}_{k} ) + Im ( {y}_{k + 50} ) + 2 / \sqrt{5} ( {\vert {h}_{k} \vert}^{2} - {\vert {h}_{k + 50} \vert}^{2} ) ] , 0 \} . & ( 23 )\end{matrix}$$

Simulations have shown that the high SNR max-log approximation results in only a loss of 0.1-0.2 dB when compared to the optimal LLR values, but at a much lower implementation complexity. The preferred approach for obtaining soft information when the DCM mode is used are (20), (21), (22), and (23).

Although an example of both an exact and approximate method for determining the LLR are disclosed, other techniques may be used to determine the LLR, and the present disclosure is not limited to particular formulas. Moreover, other statistical methods to determine the presence of errors, as known to one skilled in the art, may be used and are within the spirit and scope of the present disclosure.

FIG. 3 is a flowchart 50 of one method of joint DCM decoding. In this example embodiment, DCM receives a series of received bits (Block 52). DCM creates a 16 point constellation of the series of bits (Block 54). DCM reconstructs the series of bits from two separate pairs (Block 56). In the event of a transmission problem with one data pair, system recovers data using the other data pair (Block 58).

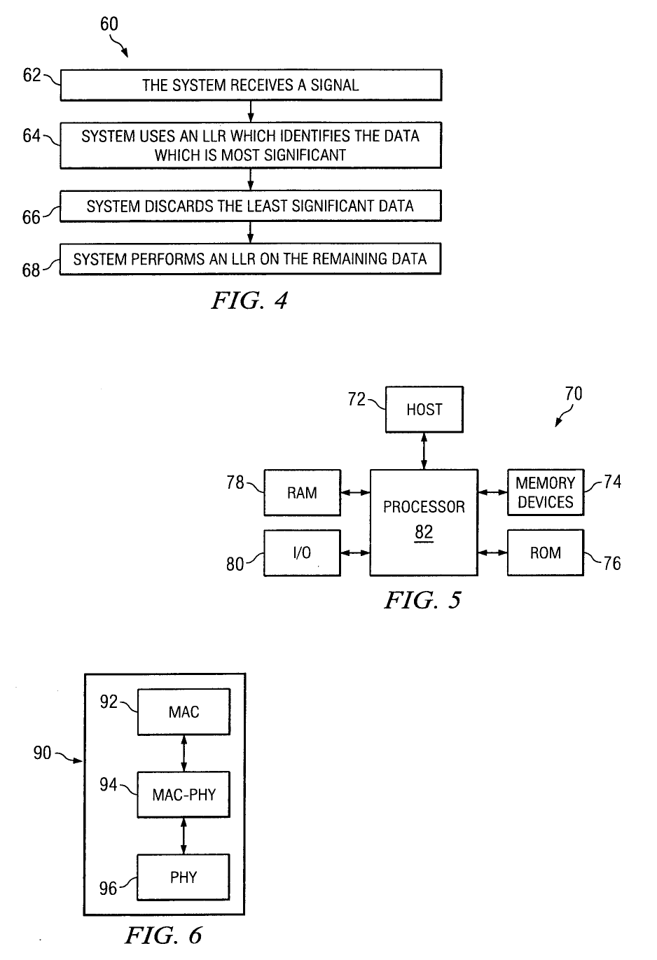

FIG. 4 is a flowchart 60 of one method of approximating joint DCM decoding using a reduced complexity ML DCM decoder system. In this example embodiment, the system receives a signal (Block 62). The system uses an LLR which identifies the data which is most significant (Block 64). System discards the least significant data (Block 66). The system performs an LLR on the remaining data (Block 68).

The present disclosure provides the ability of the DCM decoder to use various kinds of coding or decoding methods. Also, the systems disclosed herein may be used in conjunction with coded or non-coded systems. Examples of coded systems which may be used with the disclosed systems include, but are not limited to, block code systems, turbo code systems, convolutional code systems, or any combination thereof. In addition, systems which use dissimilar codes as an outer code and an inner code, such as inner convolutional code with an outer Reed Solomon or other code, for example, may be implemented. It is understood that any number error correction schemes such as forward error correction algorithms and low density parity checks may be used consistent with the present disclosure.

The systems and methods described above may be implemented on any general-purpose computer with sufficient processing power, memory resources, and network throughput capability to handle the necessary workload placed upon it. FIG. 5 illustrates a typical, general-purpose computer system suitable for implementing one or more embodiments of a system to respond to signals as disclosed herein. The computer system 70 includes a processor 82 (which may be referred to as a central processor unit or CPU) that is in communication with memory devices including secondary storage 74, read only memory (ROM) 76, random access memory (RAM) 78, input/output (I/O) 80 devices, and host 72. The processor may be implemented as one or more CPU chips.

The secondary storage 74 is typically comprised of one or more disk drives or tape drives and is used for non-volatile storage of data and as an over-flow data storage device if RAM 78 is not large enough to hold all working data. Secondary storage 74 may be used to store programs that are loaded into RAM 78 when such programs are selected for execution. The ROM 76 is a non-volatile memory device that typically has a small memory capacity relative to the larger memory capacity of secondary storage. The RAM 78 is used to store volatile data and perhaps to store instructions. Access to both ROM 76 and RAM 78 is typically faster than to secondary storage 74.

I/O 80 devices may include printers, video monitors, liquid crystal displays (LCDs), touch screen displays, keyboards, keypads, switches, dials, mice, track balls, voice recognizers, card readers, paper tape readers, or other well-known input devices. Host 72 may interface to Ethernet cards, universal serial bus (USB), token ring cards, fiber distributed data interface (FDDI) cards, wireless local area network (WLAN) cards, and other well-known network devices. This host 72 may enable the processor 82 to communicate with an Internet or one or more intranets. With such a network connection, it is contemplated that the processor 82 might receive information from the network, or might output information to the network in the course of performing the above-described method steps.

The processor 82 executes instructions, codes, computer programs, and scripts which it accesses from hard disk, floppy disk, optical disk (these various disk based systems may all be considered secondary storage 74), ROM 76, RAM 78, or the host 72.

The systems and methods described above may be implemented on devices with a MAC and a PHY. FIG. 6 illustrates an exemplary system 90 containing a MAC 92, a MAC-PHY interface 94, and a PHY 96. MAC 92 is capable, in this embodiment, of communicating with PHY 96 through MAC-PHY interface 94. MAC-PHY interface 94 may be a controller, processor, direct electrical connection, or any other system or method, logical or otherwise, that facilitates communication between MAC 92 and PHY 96. It is expressly understood that MAC 92, MAC-PHY interface 94, and PHY 96 may be implemented on a single electrical device, such as an integrated controller, or through the use of multiple electrical devices. It is further contemplated that MAC 92, MAC-PHY interface 94, and PHY 96 may be implemented through firmware on an embedded processor, or otherwise through software on a general purpose CPU, or may be implemented as hardware through the use of dedicated components, or a combination of the above choices. Any implementation of a device consistent with this disclosure containing a MAC and a PHY may contain a MAC-PHY interface. It is therefore expressly contemplated that the disclosed systems and methods may be used with any device with a MAC and a PHY.

While several embodiments have been provided in the present disclosure, it should be understood that the disclosed systems and methods may be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as directly coupled or communicating with each other may be coupled through some interface or device, such that the items may no longer be considered directly coupled to each other but may still be indirectly coupled and in communication, whether electrically, mechanically, or otherwise with one another. Other examples of changes, substitutions, and alterations are ascertainable by one skilled in the art and could be made without departing from the spirit and scope disclosed herein.

What is claimed is:

1. An ultra-wideband wireless communications system comprising:
a data input;
a decoding function, adapted to receive a first data element and a second data element from the data input and decode the first data element and second data element;
a mapping element, adapted to map the first data element and second data element onto a first constellation and a second constellation; and
a log likelihood function operable to substantially maximize log likelihood information across a first tone and a second tone using the first constellation and the second constellation.

2. The system of claim 1, wherein the first data element is a tone.

3. The system of claim 1, further comprising an ordering function that is capable of taking the order of the received elements into consideration.

4. The system of claim 3, further comprising a recovery function that is capable of extrapolating the corrected data element from the constellation.

5. The system of claim 3, wherein the log likelihood function further comprises a block code, turbo code, convolutional code, Reed Solomon code, or combination thereof.

6. The system of claim 3, wherein the coding function further comprises a convolutional code of an [R=⅓, k=7] form.

7. The system of claim 1, wherein the log likelihood function is selected from the group of functions:
$$\begin{matrix}LLR ( {b}_{2 k} ) = max \{ [ 3 Re ( {y}_{k} ) - Re ( {y}_{k + 50} ) ] , [ 2 Re ( {y}_{k} ) + Re ( {y}_{k + 50} ) + 2 / \sqrt{5} ( {\vert {h}_{k} \vert}^{2} - {\vert {h}_{k + 50} \vert}^{2} ) ] \} - max \{ [ Re ( {y}_{k} ) + 2 Re ( {y}_{k + 50} ) + 2 / \sqrt{5} ( {\vert {h}_{k} \vert}^{2} - {\vert {h}_{k + 50} \vert}^{2} ) ] , 0 \} . , \\ LLR ( {b}_{2 k + 100} ) = max \{ [ 3 Re ( {y}_{k} ) - Re ( {y}_{k + 50} ) ] , [ Re ( {y}_{k} ) + 2 Re ( {y}_{k + 50} ) + 2 / \sqrt{5} ( {\vert {h}_{k} \vert}^{2} - {\vert {h}_{k + 50} \vert}^{2} ) ] \} - max \{ [ 2 Re ( {y}_{k} ) + Re ( {y}_{k + 50} ) + 2 / \sqrt{5} ( {\vert {h}_{k} \vert}^{2} - {\vert {h}_{k + 50} \vert}^{2} ) ] , 0 \} . , \\ LLR ( {b}_{2 k + 1} ) = max \{ [ 3 Im ( {y}_{k} ) - Im ( {y}_{k + 50} ) ] , [ 2 Im ( {y}_{k} ) + Im ( {y}_{k + 50} ) + 2 / \sqrt{5} ( {\vert {h}_{k} \vert}^{2} - {\vert {h}_{k + 50} \vert}^{2} ) ] \} - max \{ [ Im ( {y}_{k} ) + 2 Im ( {y}_{k + 50} ) + 2 / \sqrt{5} ( {\vert {h}_{k} \vert}^{2} - {\vert {h}_{k + 50} \vert}^{2} ) ] , 0 \} . , \\ and \\ LLR ( {b}_{2 k + 101} ) = max \{ [ 3 Im ( {y}_{k} ) - Im ( {y}_{k + 50} ) ] , [ Im ( {y}_{k} ) + 2 Im ( {y}_{k + 50} ) + 2 / \sqrt{5} ( {\vert {h}_{k} \vert}^{2} - {\vert {h}_{k + 50} \vert}^{2} ) ] \} - max \{ [ 2 Im ( {y}_{k} ) + Im ( {y}_{k + 50} ) + 2 / \sqrt{5} ( {\vert {h}_{k} \vert}^{2} - {\vert {h}_{k + 50} \vert}^{2} ) ] , 0 \} ..\end{matrix}$$

8. A method for network communications, comprising:
receiving data with a first data pair and a second data pair;
reconstructing the data by considering a separation between the transmission of the first data pair and the second data pair;
creating two constellations using the data reconstructed;
detecting an error in the first data pair; and
recovering at least part of first data pair using the second data pair.

9. The method of claim 8, wherein each of the constellations is made up of sixteen points.

10. The method of claim 8, wherein the delay between the transmission of the first data pair and the second data pair is fifty tones.

11. The method of claim 8, wherein the network is a WiMedia network.

12. A dual-carrier modulation decoder containing instructions operable when executed to perform a method comprising:
receiving a signal containing a tone pair without frequency spreading or time spreading;
reordering the signal to account for any intermediate tones transmitted in between the tone pair; and
decoding the signal.

13. The dual-carrier modulation decoder of claim 12, wherein the decoding of a signal further comprises detecting an error within the signal.

14. The dual-carrier modulation decoder of claim 13, wherein the decoding of a signal is preformed through a exact process using the log-likelihood approximation.

15. The dual-carrier modulation decoder of claim 13, wherein the decoding of a signal is preformed through an inexact process.

16. The dual-carrier modulation decoder of claim 12, further comprising recovering from an error within the signal.

17. The dual-carrier modulation decoder of claim 15, wherein the decoding of a signal is preformed through a log-likelihood approximation.

18. The dual-carrier modulation decoder of claim 17, wherein the log-likelihood approximation is decomposed into log(exp(A)+exp(B)) and log(exp(X)+exp(Y)).

19. The dual-carrier modulation decoder of claim 17, wherein the log-likelihood approximation is simplified to log(max{exp(A),exp(B)}).

20. The dual-carrier modulation decoder of claim 12, wherein the signal is received over an OFDM-based data transmission network.
